(19) United States
(12) Patent Application Publication
(10) Pub. No.: US 2014/0297714 A1
(43) Pub. Date: Oct. 2, 2014

(54) PROVIDING BINARY IMAGES CUSTOMIZED FOR DIFFERENT USERS IN MEMORY SPACE CONSTRAINED ENVIRONMENTS

(71) Applicant: GAINSPAN CORPORATION, San Jose, CA (US)

(72) Inventors: Madan Udaykumar, Bangalore (IN); Vishal Batra, Bangalore (IN); Pankaj Vyas, Bangalore (IN)

(73) Assignee: GainSpan Corporation, San Jose, CA (US)

(21) Appl. No.: 13/854,178

(22) Filed: Apr. 1, 2013

(51) Int. Cl. H04L 29/06

(52) U.S. Cl. CPC H04L 29/06047
USPC 709/203

(57) ABSTRACT

A web-based system is provided for generating binary images customized for different users in memory space constrained environments. Inputs from a user identifying a set of features of interest in a software program, and a maximum size of memory space available for storing the software program are received. A required size of memory space for the software program, including the set of features is computed. If the required size is more than the maximum size, the user is notified that the set of features cannot be fit into the available memory space. Otherwise, a corresponding binary image implementing both of a core functionality of the software program and the set of features of interest is built. The user can retrieve the binary image from the server via the client system.

### BACKGROUND OF THE INVENTION

1. Technical Field

Embodiments of the present disclosure relate generally to memory space constrained systems such as embedded systems, and more specifically to providing binary images customized for different users in memory space constrained environments.

2. Related Art

A binary image refers to a set of software instructions ready for execution by a processor. Typically, modules of a software program (written in higher level languages such as C, C++, Java, etc.) are compiled to generate corresponding object modules in machine level formats, and are thereafter linked to form an executable binary image. The binary image thus formed can be stored in a random access memory and executed to obtain the functionality for which the software program is designed.

Often, a software program has a ‘core functionality’ and several optional peripheral features. Different customized versions of the software program are often provided integrated with different combinations of peripheral features, with each version typically tailored for the requirements specific to corresponding groups of users. Core functionality refers to the basic features (for which the software program is designed) that are integral to all such versions of the software program. Thus different versions of the software program may have different sets of modules implementing the corresponding optional peripheral features.

There is often a need to provide binary images customized for different users in memory space constrained environments. A memory space constrained environment is characterized by limited memory available for storing binary images, in that a binary image, if built to contain all the optional features, may not fit in the available limited memory space.

### BRIEF DESCRIPTION OF THE VIEWS OF DRAWINGS

Example embodiments of the present invention will be described with reference to the accompanying drawings briefly described below.

FIG. 1 is a block diagram of an example memory space constrained system.

FIG. 2 is a block diagram illustrating the manner in which customized binary images are provided according to an aspect of the present invention.

FIG. 3 is a flowchart illustrating the manner in which a network-based system operates in processing requests for customized binary images for use in a memory space constrained system, in an embodiment.

FIGS. 4-10 are example web pages displayed at a client system to enable a user to select features of interest to be included in a binary image, in an embodiment.

FIG. 11 is a block diagram illustrating block-level implementation details of server 240, in an embodiment.

FIG. 12 is a diagram illustrating a portion of a module map, in an embodiment.

FIG. 13 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

An aspect of the present invention provides a web-based system enabled to generate binary images customized for different users in memory space constrained environments. In an embodiment, inputs from a user identifying a set of features of interest in a software program, and a maximum size of memory space available for storing the software program, are received. A required size of memory space for the software program, including the set of features is computed. If the required size is more than the maximum size, the user is notified that the set of features cannot be fit into the available memory space.

Otherwise, a corresponding binary image implementing both of a core functionality of the software program and the identified set of features of interest is built. The user can retrieve the binary image from a server of a web based system using a client system.

Several aspects of the invention are described below with reference to examples for illustration. It should be understood that numerous specific details, relationships, and methods are set forth to provide a full understanding of the invention. One skilled in the relevant arts, however, will readily recognize that the invention can be practiced without one or more of the specific details, or with other methods, etc. In other instances, well-known structures or operations are not shown in detail to avoid obscuring the features of the invention.

### 2. Memory Space Constrained System

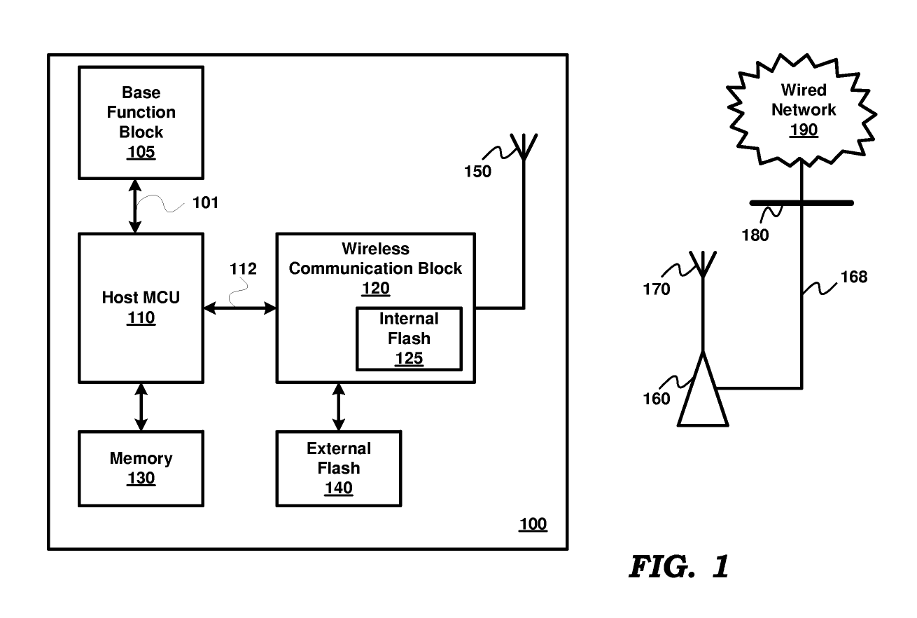

FIG. 1 is a block diagram representing an example memory space constrained system 100. FIG. 1 additionally shows access point 160, wired network backbone 180 and wired network 190. The example of FIG. 1 is shown containing only representative blocks/systems for illustration. However, real-world environments may contain many more systems/components/blocks as will be apparent to one skilled in the relevant arts.

Memory space constrained system 100 represents a system designed/implemented by an original equipment manufacturer (OEM), and may, for example, represent a refrigerator, printer, air conditioner, weighing scale, data acquisition and control unit, etc. System 100 is shown containing base function block 105, host microcontrol unit (MCU) 110, system-on-chip (SoC) 120, internal flash 125, memory 130, external flash 140, and antenna 150.

Base function block 105 performs the operations required in providing the basic function (base functionality) that system 100 is designed for. Thus, for example, when system 100 represents a refrigerator, base function block 105 performs the operations involved in cooling/heat transfer, and is assumed to contain the corresponding physical components (e.g., compressor, heat-exchanger etc.) required for refrigeration. Similarly, when system 100 represents a data acquisition and control unit, base function block 105 represents corresponding sensors (e.g., temperature/pressure sensors), signal conditioning components, etc. Base function block 105 may transmit to host MCU 110 on path 101, data representing one or more parameters (e.g., temperature/pressure values) of interest. Base function block 105 may receive from host MCU 110 on path 101, commands for controlling various operations of base function block 105.

Host MCU 110 may receive parameter values from base function module 105 on path 101, and may store the values in memory 130. Host MCU 110 may also provide commands (received, for example, from a remote system connected to wired network 190 and via Wireless communication block 120) to base function block 105 via path 101. Host MCU 110 may optionally display parameter values received from base function block 105 on a display (not shown). Host MCU 110 communicates with wireless communication block 120 via path 112 to forward parameter values to, and receive commands from, wireless communication block 120. The commands may be received from a remote system connected to wired network 190, as noted above. Memory 130 may include volatile and non-volatile memory, the non-volatile memory storing code to be executed by host MCU 110.

Wireless communication block 120, which may be implemented, for example, as a system-on-chip (SoC), provides wireless communication capabilities to system 100. In an embodiment, wireless communication block 120 implements medium access control (MAC) layer and physical layer functions specified according to IEEE 802.11 (family of) specifications, also referred to as WLAN (Wireless Local Area Network). Wireless communication block 120 contains one or more processing units or processors (not shown) to execute software instructions (firmware) required for controlling the hardware portions of Wireless communication block 120, as well as for providing network layer and other communication protocol layers required for communication. The firmware may be stored either in internal flash (memory) 125 or in external flash 140, or in both.

Antenna 150 transmits/receives signals to/from a wireless medium, and may be connected to the corresponding physical layer components in Wireless communication block 120. Wireless communication block 120 may be configured as a wireless station (for e.g., according to IEEE 802.11) and enables communication between system 100 and remote systems (e.g., those connected to wired network 190) via AP 160. Although memories 125 and 140 used by wireless communication block 120 have been noted herein as being flash memory, in alternative embodiments system 100 may in general use any other solid state non-volatile memory (e.g., ROM, EPROM, non-volatile RAM, etc.) instead, in place of internal flash 125 and external flash 140.

AP 160 communicates (exchanges data packets with system 100) via antenna 170 on a wireless medium, and with wired network 190 via network backbone 180 and wired path 168. Wired network 190 may represent the World Wide Web or internet.

Typically, an OEM purchases Wireless communication block 120 (as well as the firmware required for operation of Wireless communication block 120) from a vendor, and assembles the various blocks of FIG. 1 to produce system 100. Wireless communication block 120 including internal flash 125 (which is contained in Wireless communication block 120) may be available for purchase as a module, which may then be assembled by the OEM along with the other blocks of system 100 by soldering/mounting on one or more printed circuit boards (PCB) with the requisite interconnections among the blocks.

The OEM may produce many (e.g., several hundreds or thousands of) units of system 100. In addition, the OEM may also produce variants of system 100, the variants differing in terms of the specific features included in the firmware. Thus, for example, the OEM may produce 1000 units of system 100 with serial communication on path 112 implemented according to UART (Universal Synchronous Receiver Transmitter, an asynchronous data link standard), and another 1000 units with serial communication on path 112 implemented according to SPI (Serial Peripheral Interface, a synchronous serial data link standard). The firmware binary image may be different for the two examples noted above, with different serial communication drivers being used for the two examples. As another example, different OEMs may use different features to build their systems. Thus, while one OEM may use ‘WPA/WPA2 personal’ as the security mechanism, another OEM may use ‘WPA/WPA2PSK Enterprise’ as the security mechanism.

Accordingly, the vendor may make available to the OEM, multiple variants (or versions) of the firmware (or binary image representing the firmware) that is to be installed/loaded by the OEM in flash 125 and/or flash 140 prior to shipment or use of system 100. As noted above, all variants of the firmware, in general, have a same ‘core functionality’, but different optional peripheral features. Core functionality of the firmware provides basic operations needed for wireless communication according to a corresponding standard, for example, IEEE 802.11.

The size of internal flash 125 and external flash 140 is typically limited (due to cost/power considerations), and may not be sufficient to store the firmware with all variations/features included. Hence, the vendor of Wireless communication block 120 provides multiple variants of the firmware, each variant including a corresponding set of selectable features. The manner in which such variants can be provided to OEMs (or any other users, in general) in accordance with several aspects of the present invention, is described below reference to examples.

### 3. Flexible Approach to Provide Customized Binary Images

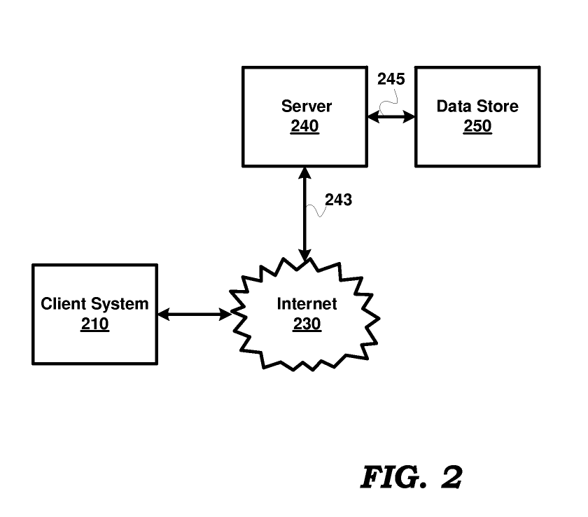

FIG. 2 is a block diagram illustrating the manner in which customized binary images are provided according to an aspect of the present invention. The vendor of Wireless communication block 120 may provide server 240 and data store 250. Various OEMs may access server 240 over Internet 230 to obtain customized firmware binary images that can be executed by various versions of Wireless communication block 120 to provide the corresponding features (in addition to the core functionality) of Wireless communication block 120. Each block of FIG. 2 is described in further detail below.

Client system 210 represents a system (digital processing system) such as a personal computer, workstation, mobile station, etc., used by an OEM to specify/select the desired set of features to be included in the binary image representing the firmware to be loaded in internal flash 125 and/or external flash 140. Client system 210 forwards the user selections to a corresponding application/software executing in server 240. Client system 210 may provide a suitable user interface (e.g., a graphical user interface) to enable the OEM to specify/select the desired features. Client system 210 may execute scripts (e.g., java scripts) in a browser and may perform computation of whether the user selections of the set of features to be included in the binary image will fit in the available memory space or not, as noted further in sections below.

Internet 230 provides network connectivity between client system 210 and server 240. Internet 230 may be implemented using protocols such as Transmission Control Protocol (TCP) and/or Internet Protocol (IP) well known in the relevant arts. In general, in TCP/IP environments, a TCP/IP packet is used as a basic unit of transport, with the source address being set to the IP address assigned to the source system from which the packet originates and the destination address set to the IP address of the target system to which the packet is to be eventually delivered.

Server 240 represents a physical machine (digital processing system) that executes corresponding application(s) for receiving, via Internet 230, the features selected at client system 210, and generates (builds) a binary firmware image that can be loaded in internal flash 125 and/or external flash 140 for execution. Server 240 may store the generated binary image in data store 250, and the binary image is available for retrieval by a user (e.g., OEM personnel, registered with server 240) via client system 210. The build operations by the application(s) executed in server 240 may include automated code modification based on the features received, automatic build to generate the firmware binary image, elimination of invalid feature combinations, organization of functions for pre-fetching, caching, and paging, etc.

Data store 250 represents a non-volatile storage facilitating storage and retrieval of data representing software instructions (e.g., source files) that are to be compiled and linked to form the firmware binary image noted above. Data store 250 may also store compilers, linkers, etc, required for building the firmware binary image. Broadly, data store 250 may be viewed as storing the data (including web pages, etc.) and instructions necessary for server 240 to providing OEMs at client systems the ability to indicate the features of interest and to provide in response, a binary image in accordance with several aspects of the present invention.

Thus, an OEM is provided the flexibility to specify different desired features for different environments, and conveniently have available the corresponding version of the software program that can be executed in wireless communication block 120 (after storing in flash 125/140). Such a feature is convenient at least in environments where OEMs may desire many number of variations of a software program. The manner in which the system of FIG. 2 processes requests for customized binary images according to an aspect, is described next with respect to a flowchart.

### 4. Processing Requests for Customized Binary Images

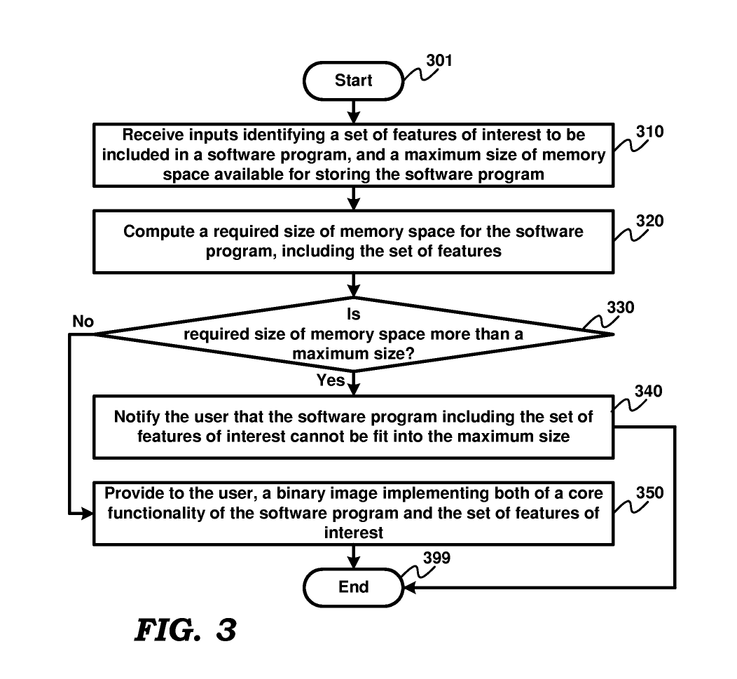

FIG. 3 is a flowchart illustrating the manner in which a network-based system operates in processing requests for customized binary images for use in a memory space constrained system, in an embodiment. The flowchart is described with respect to the environment of FIG. 2 and client system 210, merely for illustration. However, various features described herein can be implemented in other environments and using other components as well, as will be apparent to one skilled in the relevant arts by reading the disclosure provided herein. Further, the steps in the flowchart are described in a specific sequence merely for illustration. Alternative embodiments using a different sequence of steps can also be implemented without departing from the scope and spirit of several aspects of the present invention, as will be apparent to one skilled in the relevant arts by reading the disclosure provided herein. The flowchart starts in step 301, in which control passes immediately to step 310.

In step 310, client system 210 receives inputs identifying a set of features of interest to be included in a software program, as well as a maximum size of memory space available for storing the software program. The maximum size of memory equals the sum of the sizes of internal flash 125 and external flash 140, in the example of FIG. 1, assuming that the flash memories are used only for storing the binary image. However, the maximum available size can be determined consistent with the implementations of the corresponding environments, as will be apparent to one skilled in the relevant arts by reading the disclosure provided herein. The set of features can correspond to any of the optional features that are sought to be integrated in the software program. Control then passes to step 320.

In step 320, client system 210 computes a required size of memory space for the software program, including the set of features. The term ‘computing’ as used herein refers to one or more mathematical operations (which may include addition, subtraction, multiplication or division) as against mere receiving of a pre-computed value from an external system. Control then passes to step 330.

In step 330, client system 210 determines whether the required size of memory space is more than the maximum size of memory available (as specified in step 310). If the required size of memory space is more than the maximum size of memory available, control passes to step 340, and to step 350 otherwise.

In step 340, client system 210 notifies the user that the set of features cannot be fit into the available memory. The notification may be provided via visual display on the user interface of client system 210. Control then passes to step 399, in which the flowchart ends.

In step 350, client system 210 provides to the user, a binary image implementing both of a core functionality of the software program and the set of features of interest (selected in step 310). In an embodiment, client system 210 forwards the user selections made in step 310 to server 240 (server 240 is assumed to have access to the core functionality portion), with server 240 in turn building the binary image and sending it back to client system 210. The binary image is (without further processing) ready for execution by the processing unit(s) in Wireless communication block 120. Control then passes to step 399, in which the flowchart ends.

It may be appreciated that the programming logic to implement steps 310-350 may be provided by server 240, for example, in the form of scripts embedded in a web page specification. Client system 210 may render a web page corresponding to the specification (including elements for receiving inputs, etc.) and the scripts are executed automatically in the browser (in a known way) to process the user inputs. The scripts may, for example, have an approximate memory requirement for each feature, and compute the memory requirement as an addition of the requirements for all the specified features (in addition to that required for the core functionality).

It may be further appreciated that the computations for step 320 can thus be an approximation, and notification of step 340 may be based on such an approximation. Alternatively or in addition, server 240 may perform a more accurate computation (e.g., while building the binary image), considering the specific modules to be included in the image. In an embodiment, server 240 first translates each specified feature into a corresponding set of modules (in many cases multiple modules), and the union of all the modules corresponding to the specified features and also the core functionality is formed. The sets in such a union are linked to form the binary image.

As is well known, each object module contains ‘relative addresses’ within the same module, and linking entails assigning absolute addresses to such relative addresses. Linking may similarly resolve references to variables referred across different object files. The binary image formed by linking, thus represents an executable file ready to be stored in a randomly accessible memory from which a processor can retrieve and execute instructions of the image. Server 240 may accordingly provide a more accurate computation of the memory space requirements for the image.

Thus, the determination of whether the binary image to be used fits the available memory space or not, can be performed at client system 210 and/or server 240. The OEM may also be notified the extent to which the memory space requirement exceeds the available memory requirement, such that the OEM may consider removal of some of the features for the corresponding image.

The manner in which a user is enabled to select the desired set of features referred above is illustrated next with respect to example web pages rendered by a browser at client system 210.

### 5. User Interface

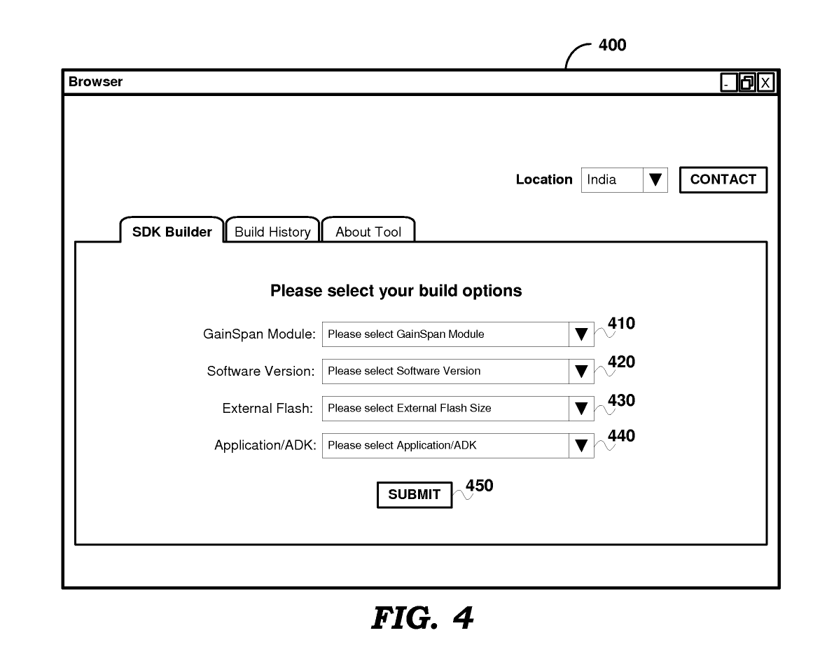

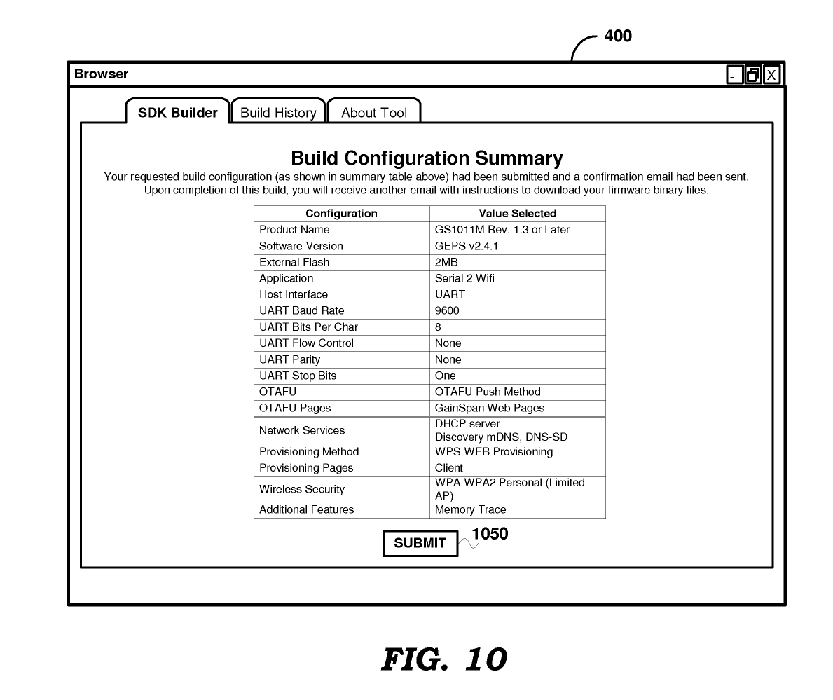

FIGS. 4 through 9 are example screen shots of web pages displayed by a browser 400 at client system 210, and illustrating the selection of features by a user/OEM, as briefly noted below. The web pages may be retrieved by browser 400 (executing on client system 210) from server 240. FIG. 10 shows a web page displaying a partial summary of the user's selections.

In the example illustrated herein, it is assumed that a single binary image is generated and eventually stored in internal flash 125. Since the image contains all linked modules, the addresses of instructions, etc., are generally with resolved values (contrasted with object files, where the addresses are relative). External flash 140 on the other hand stores the various data, web pages, backup data, etc., which can again be retrieved/manipulated by the instructions stored in internal flash 125. According to an aspect of the present invention, the sufficiency of memory is checked for both the image and the data, as described below in further detail.

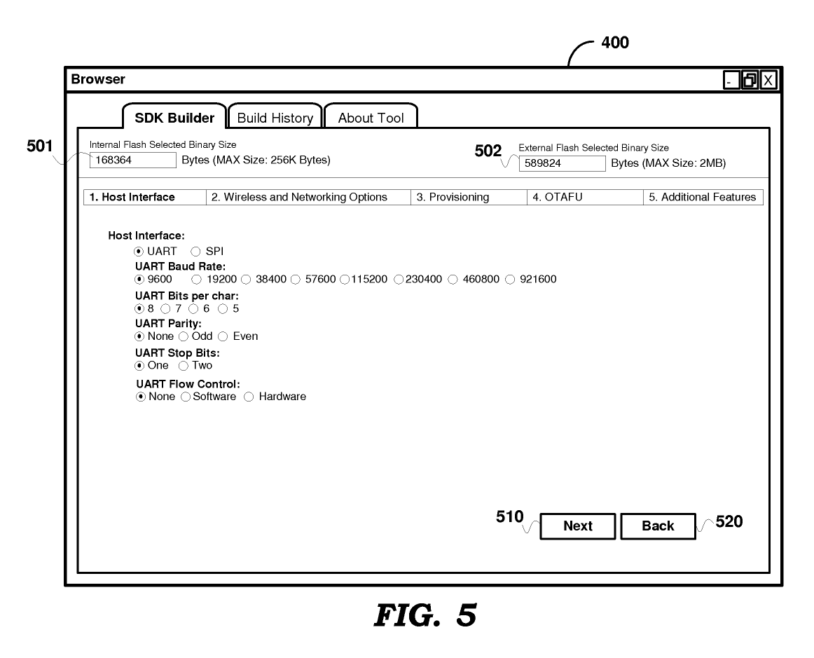

In the webpage of FIG. 4, the user is allowed to select (via drop down menu option 410) the specific module (hardware) version of Wireless communication block 120, the software version (core functionality portion) via option 420, the size of external flash (140 of FIG. 1) via option 430 and the application via option 440. The application selectable via option 440 refers to the software portion of the interface in wireless communication module 120 to host MCU 110. The user submits the selection by clicking on the “Submit’ button 450, which causes browser 400 to display the webpage of FIG. 5.

In the webpage of FIG. 5, the user selects options pertaining to the implementation type of host interface (serial link 112 of FIG. 1). The user is shown as having selected UART. The parameters for the UART serial link are also selectable by the user. Browser 400 may also display the ‘current’ size that would result if the features selected thus far are included to form the binary image, as indicated by markers 501 and 502. The maximum sizes of internal flash 125 and external flash 140 are shown to be 256 Kbytes (assumed to be fixed for all implementations, in the embodiment of FIGS. 4-9) and 2 Megabytes (based on the input at option 430) respectively in the example.

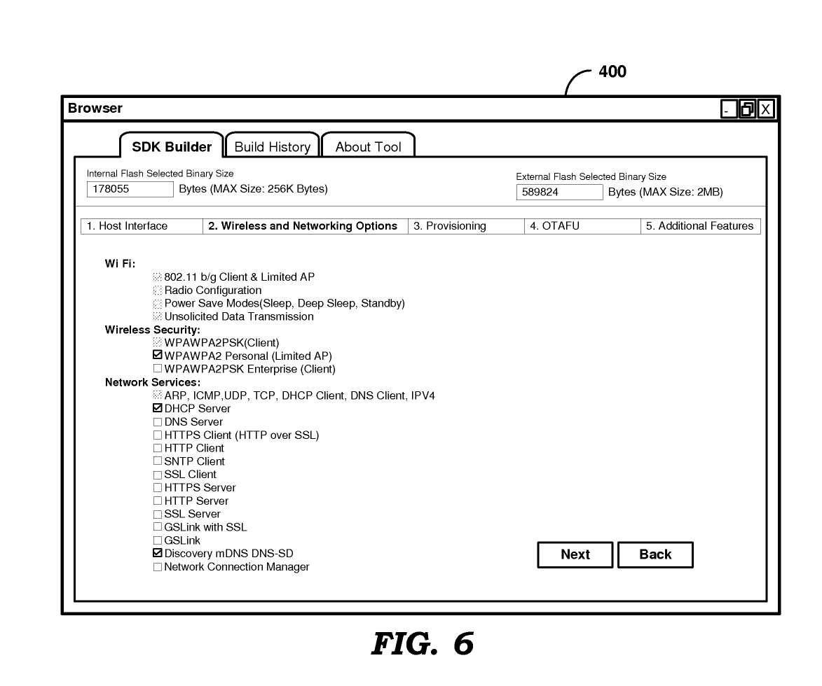

After the corresponding selections are made, the user clicks on the ‘Next’ button (510) to navigate to the next webpage (shown in FIG. 6), or the ‘Back’ button (520) to navigate back to the webpage of FIG. 4. FIGS. 6 through 9 similarly show various features that can be selected by the user via corresponding web pages, each page also displaying the ‘current’ size of the resulting binary image, as noted above with respect to FIG. 5. Thus, some of the features shown selectable by a user include WPAWPA2 Personal (Limited AP),

WPAWPA2PSK Enterprise (Client), DHCP Server, DNS Server, HTTPS Client (HTTP over SSL), HTTP Client, SNTP Client, SSL Client, HTTPS Server, HTTP Server, SSL Server, GSLink with SSL, GSLink, Discovery mDNS DNS-SD and Network Connection Manager. User-selectable features are indicated in the respective Figures by black check boxes.

It is noted that, in an embodiment, the following capabilities are part of the core functionality, and therefore not selectable by a user as a feature: 802.11b/g Client & Limited AP, Radio Configuration, Power Save Modes (Sleep, Deep Sleep, Standby),

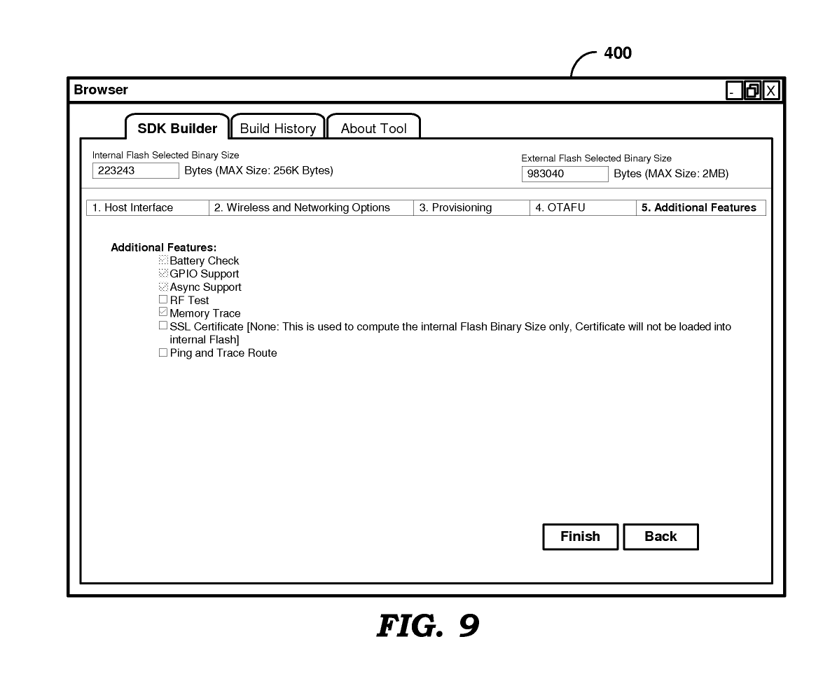

Unsolicited Data Transmission, WPAWPA2PSK(Client), ARP, ICMP, UDP, TCP, DHCP Client, DNS Client, IPV4, Battery Check, GPIO Support and Async Support. These capabilities are shown as ‘preselected’, as indicated by the grayed check boxes in FIGS. 6 and 9. However, in other embodiment, some of the above-noted capabilities may also be provided as features selectable by a user.

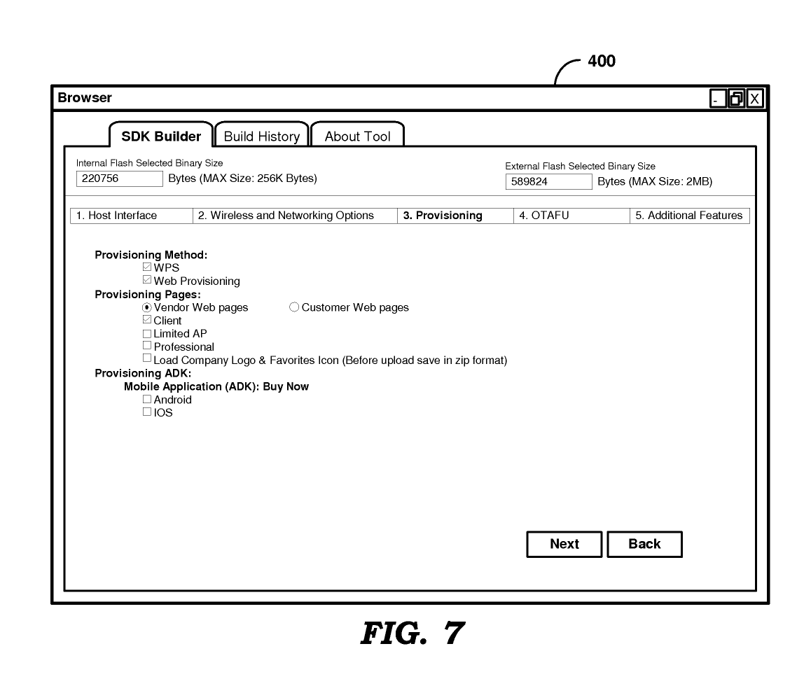

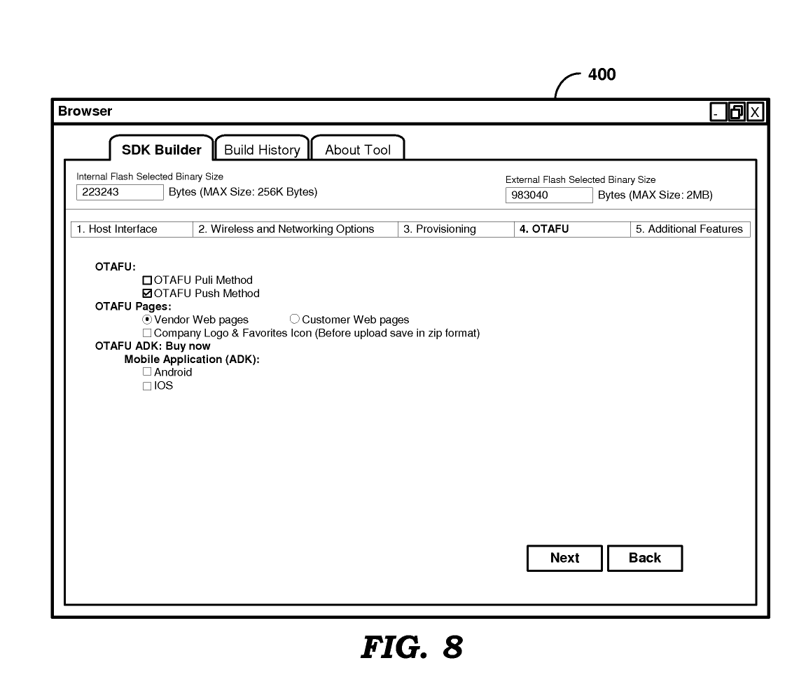

With respect to FIG. 7, the provisioning method to be used for provisioning Wireless communication block 120 (which may operate as a wireless station according to IEEE 802.11) is shown to be selectable both via WPS (WiFi Protected Setup) as well as via web provisioning. As is well known in the relevant arts, the term ‘provisioning’ in the context of IEEE 802.11 refers to providing information to a wireless station about which wireless network (or AP) to connect to. OTAFU (Over The Air Firmware Update) shown in the web page of FIG. 8 refers to a facility of updating the firmware binary image (once stored in flash 125/140) by an external system (connected to wired network 190) via the IEEE 802.11 wireless link provided by wireless communication block 120.

It may be observed from the web pages of FIGS. 4-9, that each feature represents an aspect that a user interacts with or experiences (contrasted, for example, with selection of modules/files directly). For example, the features “Provisioning Method” of the web page of FIG. 7 allows a user (via corresponding user actions) to provision system 100 using WPS or web provisioning. Thus, by relying on features at such a level, the users interacting with the user interface of FIGS. 4-9, may conveniently operate at a level that is generally convenient for the users.

The web page of FIG. 10 shows a summary of the features selected by the user via the web pages of FIGS. 4 through 9. It may be observed, for example, that the summary includes the host interface parameters selected by the user in the web page of FIG. 5. The user submits the features selected by clicking on the ‘Submit’ button 1050.

It may be appreciated that markers 501 and 502 are updated to reflect the expected aggregate memory space in flash units 125 and 140 respectively, as the user continues to select features of interest. If the size of the resulting binary image would exceed the maximum available memory space (in flash 125 and/or flash 140), browser 400 may display that the binary image cannot be built, and force the user to change selections.

Thus, once a user selects features that are within the limits of the available memory space, client system 210 forwards the set of selected features and the data identifying user inputs as to memory space availability, to server 240. Server 240 may then make a more accurate computation of the memory space requirements, and notify the user (e.g., via electronic mail (email) offline) that the available memory space is not sufficient to contain the binary image. On the other hand, if the available memory space is sufficient, server 240 performs the necessary operations such as compiling and linking to generate the binary image, which the user can then retrieve from server 240 via client system 210.

In an embodiment, client system 210 does not forward (i.e., submit) the selected set of features to server 240 if client system 210 determines that the available memory space would be insufficient to contain the binary image when built. In the embodiment, once client system 210 submits the set of features to server 240 (after determining that the available memory space is sufficient to contain the binary image when built), client system 210 also notifies the user via email that the set of features has been submitted. Server 240 then makes a more accurate computation of the memory space requirements ensures that the selected set of features are included in the binary image to be built. Server 240 may perform multiple iterations and dynamically figure out changes to be made to fit the feature set so that the build succeeds. Once the build is successful, server 240 notifies the user via email that the submitted set of features were included successfully in the built binary image.

It should be appreciated that an OEM may use interfaces such as the above to obtain a binary image. The user inputs in screens of FIGS. 4-9 represent the memory configuration available in a class of systems, and the specific features the OEM intends to provide in such class of systems. Therefore the binary image received thereafter, is installed in each of such class of systems. The OEM may provide different values in the screens of FIGS. 4-9 for obtaining binary images (of respective versions of the software program) suited for different classes of systems (for use in respective types of environments).

The block-level implementation details of server 240 are described next with respect to an embodiment.

### 6. Server

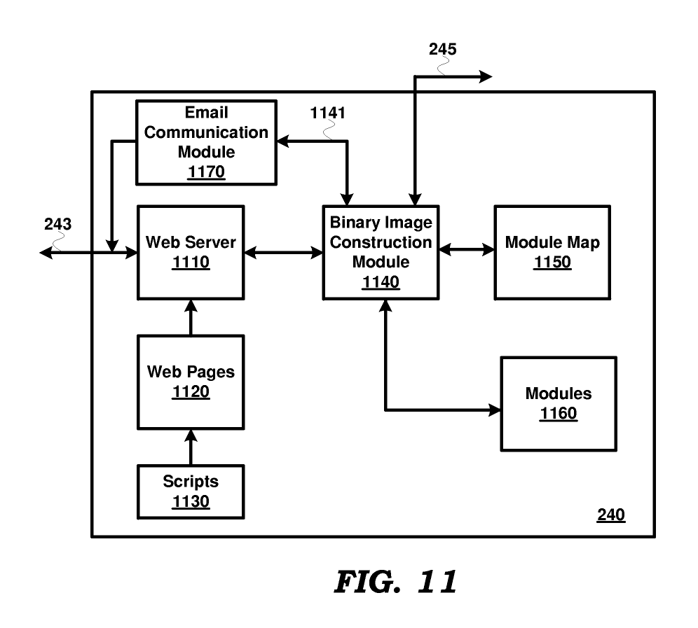

FIG. 11 is a block diagram illustrating block-level implementation details of server 240, in an embodiment. Server 240 is shown containing web server 1110, web pages 1120, scripts 1130, binary image construction module 1140, module map 1150, modules 1160, and email communication module 1170. In addition, although not shown in FIG. 11, server 240 may also contain firewall, security tools, etc.

Module map 1150 contains a map, which can be used to identify the set of modules to be incorporated into the binary image, for providing each of the features that can be selected by a user using the interfaces described above with respect to FIGS. 4-9. Modules 1160 represents the object code corresponding to each of said set modules. Though shown as being available within server 240, module map 1150 and modules 1160 may be retrieved from data store 250.

Scripts 1130 contain the programming logic executed when web pages are rendered in the browsers of client system 210, as well as that used on server 240 for various checks and to build the binary image. The programming logic may compute the available memory space in markers 501/502 (without having to rely on web server 1110 for such a functionality) and provide other rich functionality in combination with elements defined as a part of HTML content, as explained above.

Web pages 1120 represent the static content that is sent to client systems 210 for rendering in corresponding browser 400. Some of scripts 1130 are embedded in web pages 1120 before being sent to client system 210. Examples of the web pages transmitted by web server 1110 are noted above with respect to FIG. 4 through 10.

Web server 1110 retrieves web pages 1120 and transmits the web pages on path 243 to client system 210, in response to a user request to access web pages at a corresponding URL. Subsequently, web server 1110 receives the set of features selected by a user at client system 210 (and data indicating available memory space), and forwards the received information to binary image construction module 1140. The web server 1110 may also facilitate a user to download the binary image, once it is constructed and available for the requesting user, as described below.

Email communication module 1170 receives messages from binary image construction module 1140, and generates corresponding electronic mail (email) for transmission to client system 210 via path 243.

Binary image construction module 1140 analyzes module map 1150 to determine the set of modules required for building the binary image corresponding to each of the set of features received (and also including the core functionality portion). The union of all such sets forms the set of modules that are to be incorporated in the binary image. The size of the memory space required for storing the binary image is computed based on the sizes of the modules in the union, or alternatively such size may be determined once the image is constructed.

Binary image construction module 1140 retrieves the corresponding modules (including those identified as being required for implementing the core functionality) from modules 1160 (which may also be stored in data store 250, as noted above), and builds the binary image by linking the modules. Such building/linking can be performed in a known way. In forming (or prior to forming) the binary image, binary image construction module 1140 may perform several operations such as, for example, automated code elimination of invalid feature combinations, organization of functions for pre-fetching, caching, and paging, etc., well known in the relevant arts. As noted above, such binary image may be stored in internal flash 125. The binary image can be made available in the form of a file for downloading via the Internet.

Binary image construction module 1140 may further generate another file containing the data (e.g., the parameter values according to the applicable standards), the web pages, etc. The data can be directly loaded into external flash 140, and the program logic of the binary image may be designed to access (from external flash 140) the data desired in specific programming context according to any pre-specified convention.

Binary image construction module 1140 may store the binary image and data file in data store 250 via path 245 for later retrieval (as, for example, on receipt of request from client system 210). Binary image construction block 1140 may send messages on path 1141 to email communication block 1170 indicating whether the build of the binary image (and corresponding data file) was successful or not, if the available memory space is sufficient to store the (built) binary image or not, etc. In response, email communication module transmits a corresponding email, addressed to client system 210, on path 243.

In the example business context noted above, an OEM may retrieve the two files, and stores the binary image in internal flash 125 and the data in the data file in external flash 140. As the instructions in internal flash 125 are already linked, a processor in wireless communication block 120 executes the instructions in internal flash 125 (while accessing any required data from external flash 140) to provide various features described above with respect to FIG. 1.

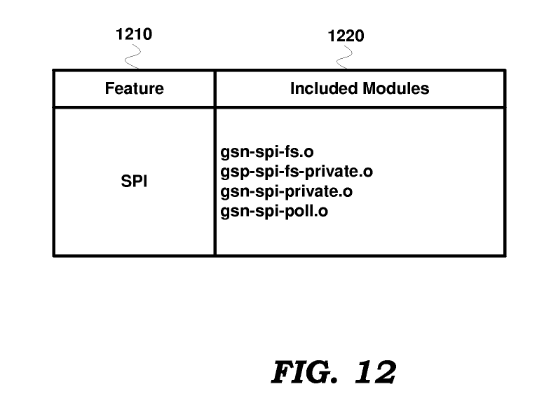

FIG. 12 shows a table of a partial portion of module map 1150. Column 1220 (“Included Modules”) is shown listing the object-level modules (gsn-spi-fs.o, gsp-spi-fs-private.o, gsn-spi-private.o and gsn-spi-poll.o) corresponding to feature SPI listed in column 1210. Thus, when a user selects SPI as serial link 112 in the webpage of FIG. 5, binary image construction module 1140 includes the object-level modules gsn-spi-fs.o, gsp-spi-fs-private.o, gsn-spi-private.o and gsn-spi-poll.o in building the binary image. Example entries of module map 1150 are listed in Appendix A.

In Appendix A, column 1 lists the feature selectable by a user, column 2 lists the source files corresponding to the feature, column 3 is the name of the corresponding (software) sub-system that provides the feature, column 4 lists the size (in bytes) of object code of the corresponding sub-system, and column 5 lists the object files corresponding to the feature. It is noted that a single feature may require multiple software sub-systems. Thus, for each feature, binary image construction module 1140 links all the corresponding multiple software sub-systems. For example, feature WPS would require sub-systems named supplicant, GEPS, Serial2Wifi, as noted in Appendix A. Hence, to provide feature WPS, binary image construction module 1140 links the object files corresponding to all the corresponding sub-systems. It is noted that a source file may have a single corresponding object file (code only, noted in Appendix A as .text) or have corresponding a code file as well as data file (noted in Appendix A as .rodata). Some of the details corresponding to feature SPI are also noted above with respect to FIG. 12.

The description is continued with respect to a digital processing system in which various features are operative when the corresponding executable modules are executed.

### 7. Digital Processing System

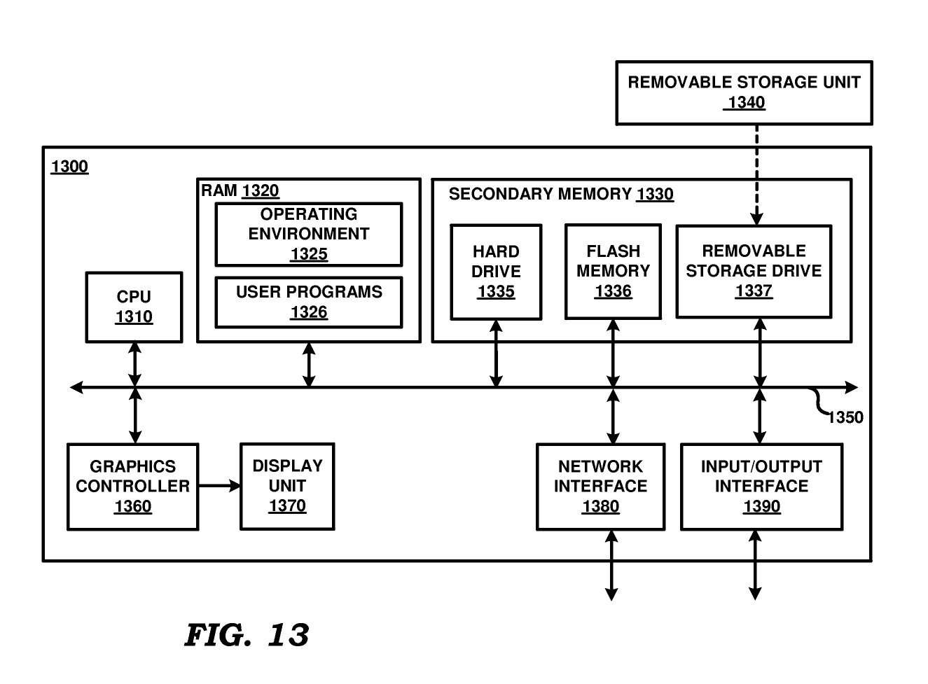

FIG. 13 is a block diagram illustrating the details of digital processing system 1300 in which various aspects of the present invention are operative by execution of appropriate executable modules. Digital processing system 1300 may correspond to either server 240 or client system 210.

Digital processing system 1300 may contain one or more processors (such as a central processing unit (CPU) 1310), random access memory (RAM) 1320, secondary memory 1330, graphics controller 1360, display unit 1370, network interface 1380, and input/output interface 1390. All the components except display unit 1370 may communicate with each other over communication path 1350, which may contain several buses as is well known in the relevant arts.

CPU 1310 may execute instructions stored in RAM 1320 to provide several features of the present invention. The executed instructions may first be copied from secondary memory 1330 to RAM 1320 prior to execution by CPU 1310. CPU 1310 may contain multiple processing units, with each processing unit potentially being designed for a specific task. Alternatively, CPU 1310 may contain only a single general-purpose processing unit.

RAM 1320 may receive instructions from secondary memory 1330 using communication path 1350. RAM 1320 is shown currently containing software instructions constituting shared environment 1325 and/or user programs 1326. Shared environment 1325 contains utilities shared by user programs, and such shared utilities include operating system, device drivers, etc., which provide a (common) run-time environment for execution of user programs/applications.

Graphics controller 1360 generates display signals (e.g., in RGB format) to display unit 1370 based on data/instructions received from CPU 1310. Display unit 1370 contains a display screen to display the images defined by the display signals. When system 1300 corresponds to client system 210, display unit 1370 displays the web pages of FIGS. 4 through 9. Input/output interface 1390 includes input (e.g., keyboard, mouse) as well as output devices to enable a user to interact with system 1300. Thus, when system 1300 represents client system 210, input/output interface 1390 enables a user to select a desired set of features via the corresponding web pages.

Network interface 1380 provides the electrical and protocol interfaces to enable system 1300 to communicate with other systems on a network (e.g., using Internet Protocol).

Secondary memory 1330 (representing a non-transitory machine/computer readable storage/medium) may contain hard drive 1335, flash memory 1336, and removable storage drive 1337. Secondary memory 1330 may store data and software instructions, which enable digital processing system 1300 to provide several features in accordance with the present invention. Thus, when system 1300 represents server 240, the software instructions corresponding to the blocks 1110/1140/1160 of FIG. 11 may be stored in secondary memory 1330. The data/text corresponding to blocks 1120/1130 and 1150 may also be stored in secondary memory 1130. When system 1300 represents client system 210, the software instructions implementing browser 400, communication module to communicate with internet 230, etc., may be stored in secondary memory 1330.

Some or all of the data and instructions may be provided on removable storage unit 1340, and the data and instructions may be read and provided by removable storage drive 1337 to CPU 1310. Floppy drive, magnetic tape drive, CD-ROM drive, DVD Drive, Flash memory, removable memory chip (PCMCIA Card, EPROM) are examples of such removable storage drive 1337.

Removable storage unit 1340 may be implemented using medium and storage format compatible with removable storage drive 1337 such that removable storage drive 1337 can read the data and instructions. Thus, removable storage unit 1340 includes a computer readable storage medium having stored therein computer software and/or data. However, the computer (or machine, in general) readable storage medium can be in other forms (e.g., non-removable, random access, etc.).

### 8. Conclusion

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

APPENDIX A

| | | | Column 4 | |
|---|---|---|---|---|
| Column 1 | Column 2 | Column 3 | Size | Column 5 |
| Feature | Source Files | Part of | (bytes) | Object Files |
| WPS | Config_flash.c | Supplicant | 12070 | .text->.supp.text |
| | | | | libsupplicant.a(config_flash.o) |
| | Eap.c | | | .text->.supp.text |
| | | | | libsupplicant.a(eap.o) |
| | | | | .rodata->.supp.rodata |
| | | | | libsupplicant.a(eap.o) |
| | Eapol_sm.c | | | text->.supp.text |
| | | | | libsupplicant.a(eapol_sm.o) |
| | | | | .rodata->.supp.rodata |
| | | | | libsupplicant.a(eapol_sm.o) |
| | Eap_wps.c | | | .text->.supp.text |
| | | | | libsupplicant.a(eap_wps.o) |
| | | | | .rodata->.supp.rodata |
| | | | | libsupplicant.a(eap_wps.o) |
| | Gsn_supplicant.c | | | .text->.supp.text |
| | | | | libsupplicant.a(gsn_supplicant.o) |
| | Wpa_supplicant.c | | | .text->.supp.text |
| | | | | libsupplicant.a(wpa_supplicant.o) |
| | | | | .rodata->.supp.rodata |
| | | | | libsupplicant.a(wpa_supplicant.o) |
| | Wps.c | | | .text->.supp.text |
| | | | | libsupplicant.a(wps.o) |
| | | | | .rodata->.supp.rodata |
| | | | | libsupplicant.a(wps.o) |
| | Gsn_wdd.c | GEPS | 918 | .text->.libgsn_fl0.text gsn_wdd.o |
| | | | | .rodata->.libgsn_fl0.rodata |
| | | | | gsn_wdd.o |
| | s2w_app_hal_general.c | Serial2Wifi | 1096 | .text->.app_files.text |
| | | | | s2w_app_hal_general.o |
| | | | | .rodata->.app_files.rodata |
| | | | | s2w_app_hal_general.o |
| | s2w_general_command.c | | | .text->.app_files.text |
| | | | | s2w_general_command.o |
| | | | | .rodata->.app_files.rodata |
| | | | | s2w_general_command.o |
| | s2w_misc_command.c | | | .text |
| | | | | s2w_misc_command.o |
| | | | | .rodata |
| | | | | s2w_misc_command.o |
| SPI | gsn_spi_fs.c | GEPS | 1496 | gsn_spi_fs.o |
| | gsn_spi_fs_private.c | | | gsn_spi_fs_private.o |
| | gsn_spi_private.c | | | gsn_spi_private.o |
| | gsn_spi_poll.c | | | gsn_spi_poll.o |
| DHCP | gsn_dhcp_srvr.c | GEPS | 476 | .text gsn_dhcp_srvr.o |
| Server | | | | |
| | app_init.c | | | .text->.app_files.text app_init.o |
| | | | | .rodata->.app_files.rodata |
| | | | | app_init.o |
| | s2w_app_hal_general.c | | | .text->.app_files.text |
| | | | | s2w_app_hal_general. o |
| | | | | .rodata->.app_files.rodata |
| | | | | s2w_app_hal_general. o |
| | s2w_app_hal_misc.c | | | .text s2w_app_hal_misc.o |
| | | | | .rodata |
| | | | | s2w_app_hal_misc.o |
| | s2w_general_command.c | | | .text->.app_files.text |
| | | | | s2w_general_command.o |
| | | | | .rodata->.app_files.rodata |
| | | | | s2w_general_command.o |
| | s2w_misc_command.c | | | .text |
| | | | | s2w_misc_command.o |
| | | | | .rodata |
| | | | | s2w_misc_command.o |
| | s2w_process.c | Serial2Wifi | 980 | .text->.app_files.text |
| | | | | s2w_process.o |
| | | | | .rodata->.app_files.rodata |
| | | | | s2w_process.o |

What is claimed is:

1. A method of processing requests for binary images of a software program customized for different users, said method comprising:
receiving inputs from a user identifying a set of features of interest in said software program, and a maximum size of memory space available for storing said software program;
computing a required size of memory space for said software program, including said set of features; and
if said required size is more than said maximum size, notifying said user that said set of features cannot be fit into said maximum size.

2. The method of claim 1, if said required size is less than said maximum size, further comprising:
building a binary image, said binary image containing modules implementing both of a core functionality of said software program and said set of features of interest; and
providing said binary image to said user as a response to said receiving of said inputs.

3. The method of claim 2, wherein said inputs are received by a server system over a network, said user providing said inputs at a client system, said building being performed in said server.

4. The method of claim 3, wherein said computing and said notifying are performed in said client system.

5. The method of claim 3, wherein said computing is performed in said server system, and said notifying comprises sending a packet from said server system to said client system, said packet containing text informing said user that said required size is more than said maximum size.

6. The method of claim 3, wherein said user represents an OEM (original equipment manufacturer), and said inputs represent a single configuration in a class of systems and the features sought to be provided in said class of systems such that said binary image formed for said inputs is suitable for installation in said class of systems.

7. The method of claim 6, wherein each of said set of features represents an aspect that a user interacts with or experiences, wherein said building comprises:
identifying a respective plurality of modules corresponding to each feature; and
linking all of said plurality of modules corresponding to said features to form said binary image.

8. The method of claim 6, wherein said software program is designed to enable a wireless communication block of a first system in said class of systems to provide said first system with the capability of wireless communication with other systems over a network.

9. The method of claim 8, wherein said wireless communication is designed according to IEEE 802.11 standards, wherein said other systems include an access point, said wireless communication block being designed to operate as a wireless station according to IEEE 802.11 standard.

10. The method of claim 9, wherein said first system includes a base function block implementing a base functionality, wherein said base function block generates one or more parameter values, wherein said wireless communication block transmits said one or more parameter values to a second system in said other systems via said access point.

11. The method of claim 10, wherein said base function block receives commands for controlling various operations of said base function block from said second system via said access point and said wireless communication block.

12. A computing system comprising:
a client system enabled to send, as a request on a network, a set of features of a software program selected by a user; and
a server enabled to:
receive said request on said network;
identify a set of modules that are designed to provide said set of features;
linking a plurality of modules to construct a binary image representing said software, said plurality of modules including said set of modules and also modules implementing a core functionality of said software program; and
send said binary image, as a response to said request.

13. The computing system of claim 12, wherein an OEM (Original Equipment Manufacturer) uses said client system to send said request, and receives said binary image as said response,
wherein said OEM stores said image in a non-volatile memory of a memory constrained system,
wherein said memory constrained system contains a processor to retrieve instructions of said binary image and execute the retrieved instructions.

14. The computing system of claim 13, wherein said server is further enabled to:
compute a size of said binary image; and
if a size of said binary image is greater than an available memory in said memory constrained system then notifying said OEM by electronic mail that said binary image said server is further

15. The computing system of claim 14, wherein said binary image when executed by said processor enables said memory constrained system to communicate wirelessly according to IEEE 802.11 standards.

16. A non-transitory machine readable medium storing one or more sequences of instructions for causing a server to process requests for binary images of a software program customized for different users, wherein execution of said one or more sequences of instructions by one or more processors contained in said server causes said server to perform the actions of:
receiving inputs from a user identifying a set of features of interest in said software program, and a maximum size of memory space available for storing said software program;
computing a required size of memory space for said software program, including said set of features; and
if said required size is more than said maximum size, then notifying said user that said set of features cannot be fit into said maximum size.

17. The non-transitory machine readable medium further comprising instructions for:
building a binary image, said binary image containing modules implementing both of a core functionality of said software program and said set of features of interest; and
providing said binary image to said user as a response to said receiving of said inputs.

18. The non-transitory machine readable medium of claim 17 wherein said inputs are received by said server over a network, said user providing said inputs at a client system.

19. The non-transitory machine readable medium of claim 18, wherein said notifying comprises sending a packet from said server to said client system, said packet containing text informing said user that said required size is more than said maximum size.

20. The non-transitory machine readable medium of claim 19, wherein said user represents an OEM (original equipment manufacturer), and said inputs represent a single configuration in a class of systems intended to be deployed with said binary image.
